(19) United States
(12) Patent Application Publication
(10) Pub. No.: US 2024/0054576 A1
(43) Pub. Date: Feb. 15, 2024

(54) CAMERA BOOTH IMPLEMENTED BUILDING INFORMATION MANAGEMENT AND PAYMENT SYSTEM

(71) Applicant: Reshaud M. Henry, Madisonville, LA (US)

(72) Inventor: Reshaud M. Henry, Madisonville, LA (US)

(21) Appl. No.: 17/887,308

(22) Filed: Aug. 12, 2022

(51) Int. Cl. G06Q 50/08; G06Q 10/06; G06Q 20/30; H04N 5/247; H04N 7/18; G06V 10/75; G06V 30/422

(52) U.S. Cl. CPC G06Q 50/08; G06Q 10/063118; G06Q 20/308; H04N 5/247; H04N 7/181; G06V 10/75; G06V 30/422

(57) ABSTRACT

Disclosed is a system and a method for building information management and automatic payment system depending on the progress of building construction. The system for managing information related to an under-construction building structure monitors one or more construction operations related to construction of the building structure. The system includes one or more data capturing devices for monitoring and capturing information related to the one or more construction operations. The data capturing devices sends the captured information to a computing device that further analyze the progress in the building construction by matching the current construction status with the actual intended drawings of the building construction. Based on the analyzed matches, a scheduled payment is made to the officials who are involved in the construction of the building, till the current construction status.

### BACKGROUND OF THE INVENTION

### Field of the Invention

The present invention generally relates to a data collection and management system. More specifically, the present invention relates to a system and a method of building information management and automatic payment system.

### Description of the Related Art

Generally, a construction projects is manually managed by contractors, engineers or operators at the construction site. Such officials may or may not be the area experts, such as an architect who has designed the actual construction drawings. Thus, at times during the construction, errors or defects might happen, which may be noticed at a later stage, and would require either deconstruction, or alteration of that particular location. Thus, it results in increased costs and dissatisfaction in the quality.

Hence, a construction management company may be particularly involved in managing operations related to the construction, such as design, development, construction errors, schedules and the like. However, again such a construction management company may inspect the sites and location, and few experts of the company may manually inspect the construction.

However, manually visiting a site, and inspection would increase the construction time, and/or errors during the visits, and thus, would not solve the entire problem of delay and accuracy of the project. Additionally, sometimes it will take more time, as the experts manually inspects any image of the construction site, and try to find out errors at the later stage, when the image is already taken and the construction is already done. Such late response results again in causing the same problem of deconstruction, or alteration and thus causing wastage of money, resources, skills and time.

Further, the payments are linked to the construction site, for example, payments for the builders, maintenance, electricity, and the like are made upon achieving a predefined construction milestone. At times, such payments are to be made without any inspection. Even if inspection is made, the payments might have to be made even for an erroneous construction work, for a deconstruction work and a for reconstruction work. In some scenario, the payments are made through manual conventional means only, for example, cash or bank transfers. This again raised an issue for the late payments, which in turn hampers the schedule of the construction.

Therefore, there is a need for a system and a method for building information management and automatic payment system that monitors the progress of construction in real time, and make automatic payments on a timely schedule as and when a predefined progress of construction is finished. Further, the proposed system and a method should detect any errors or defects in the construction design, as and when it is made, in real time, or at least within a very least time.

Moreover, in some instances, the building information management and automatic payment system themselves may have some aesthetic shortcomings. For example, depending on the event and whether the event is a formal event, the building information management and automatic payment system may appear undesirably worn, may be a wrong color, or may be otherwise unsightly. Further, in some instances, companies, schools and other entities sponsor events and seek to display their logos, names, symbols or other indicia on building information management and automatic payment system as a method of marketing or advertising. This is often done by placing stickers or taping signs onto the building information management and automatic payment system that include the logo, name, symbol, or other indicia. However, this method may appear unprofessional and in addition, once adhered, the stickers can be challenging to remove and tape can leave residue on the building information management and automatic payment system that attracts dirt.

Therefore, yet another object of the present invention is to provide new and improved devices that overcome the aesthetic shortcomings of existing building information management and automatic payment system.

As disclosed in this application, the inventor has discovered novel and unique devices and methods for efficiently and effectively providing building information management and automatic payment system. The devices and methods disclosed herein avoid many of the drawbacks of existing methods and devices. Embodiments of the present invention provide for building information management and automatic payment system as described and defined in the description below and in the annexed claims which provide for improved efficiency and effectiveness characteristics in order to conveniently and more efficiently sell building information management and automatic payment system, in a multitude of environments.

### SUMMARY OF THE INVENTION

It is one prospect of the present invention to provide a novel camera booth implemented building information management and payment system which includes a plurality of wireless pole mounted cameras, wirelessly connected to a computing device through a wireless computer network. The plurality of wireless pole mounted cameras are adapted to be positioned at a plurality of respective locations about a building construction site.

Preferably, each wireless pole mounted camera is programmed to capture two-dimensional (2D) images of the building construction site at the plurality of locations around the building construction site. Each wireless pole mounted camera is programmed to send the captured two-dimensional (2D) images over the wireless computer network to the computing device. The wireless computer network is connected to the Internet.

The computing device includes at least one processor and a memory storage device coupled to the at least one processor. A plurality of building construction drawings are stored on the memory storage device. A predetermined payment schedule is also stored on the memory storage device.

In a preferred embodiment, plurality of predetermined milestones is also stored on the memory storage device, wherein each predetermined milestone includes a respective set of building construction drawings of a plurality of building construction drawings. Each predetermined milestone associated with a respective payment amount, and is defined by a predetermined payment schedule. The computing device is programmed to perform a viewpoint determination of milestone matches between the captured two-dimensional (2D) images and the respective sets of building construction drawings associated with each predetermined milestone.

Preferably, the computing device is also programmed to send an electronic communication over the Internet and adapted for receipt by a financial institution/system. The financial institution/system comprises a bank account/system configured to release the respective payment amount to at least one of the contractor/engineer on verifying the viewpoint determination of milestone matches.

In another preferred embodiment, a method for implementing a building information management and payment system including steps of: (a) A plurality of wireless pole mounted cameras are positioned at a plurality of respective locations around a building construction site. Further, the plurality of wireless pole mounted cameras are programmed to respectively capture two-dimensional (2D) images of the building construction site at the plurality of locations around the building construction site. Each wireless pole mounted camera is also programmed to send the captured two-dimensional (2D) images over the wireless computer network to the computing device. (b) The plurality of wireless pole mounted cameras are wirelessly connected to a computing device through a wireless computer network. The wireless computer network is connected to the Internet. The computing device includes at least one processor coupled to at least one memory storage device. (c) The plurality of building construction drawings for a building construction site are stored on the at least one memory storage device. (d) A predetermined payment schedule is stored on the at least one memory storage device. (e) A plurality of predetermined milestones is stored on the at least one memory storage device. The predetermined milestone includes a respective set of building construction drawings of the plurality of building construction drawings. Each predetermined milestone associated with a respective payment amount defined by the predetermined payment schedule. (f) The plurality of wireless pole mounted cameras captures two-dimensional (2D) images of the building construction site at the plurality of locations around the building construction site. (g) The plurality of wireless pole mounted cameras send the captured two-dimensional (2D) images over the wireless computer network to the computing device. (h) The processor performs a viewpoint determination of milestone matches between the captured two-dimensional (2D) images and the respective sets of building construction drawings associated with each predetermined milestone. (i) The one or more milestone matches is generated by the processor when the captured two-dimensional (2D) images match the respective sets of building construction drawings associated with each predetermined milestone based upon the viewpoint determination. (j) One or more milestone match electronic messages is generated by the processor upon the generation of a milestone match. (j) The one or more milestone match electronic messages are send by the processor over the Internet to a financial institution. The financial institution includes a bank account/system, wherein the receipt of a respective milestone match electronic messages releases to at least one contractor/engineer, the respective payment amount associated with the milestone match in accordance with the predetermined payment schedule.

While a number of features are described herein with respect to embodiments of the inventions; features described with respect to a given embodiment also may be employed in connection with other embodiments. The following description and the annexed drawings set forth certain illustrative embodiments of the inventions. These embodiments are indicative, however, of but a few of the various ways in which the principles of the inventions may be employed.

These and other features, aspects, and advantages of the present invention will become apparent to one with skill in the art upon examination of the following detailed description when considered in conjunction with the drawings. It is intended that all of the systems, methods, features and advantages be included within this description, be within the scope of the invention, and be protected by the accompanying claims.

### BRIEF DESCRIPTION OF THE DRAWINGS

Illustrative embodiments of the present invention are described herein with reference to the accompanying drawings, in which:

FIG. 1 illustrates an exemplary diagram showing a system including multiple devices, installed outside of an under-construction building site, for building information management, in accordance with embodiments of the present invention;

FIG. 2 illustrates an exemplary diagram showing a system including multiple devices, installed inside of an under-construction building site, for building information management, in accordance with embodiments of the present invention;

FIGS. 3A-3B illustrate an exemplary diagram for comparison between an image captured of the outside of the under-construction building with a building plan drawing of outside of an intended building structure, in accordance with embodiments of the present invention;

FIGS. 4A-4B illustrate an exemplary diagram for comparison between an image captured of the inside of the under-construction building with a building plan drawing of inside of an intended building structure, in accordance with embodiments of the present invention; and

FIG. 5 illustrates an exemplary flowchart showing a method for managing building information of the under-construction building site and managing automatic payment related to the under-construction building site, in accordance with embodiments of the present invention.

### DETAILED DESCRIPTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

Reference will now be made in detail to the present preferred embodiments of the invention, examples of which are illustrated in the accompanying drawings. Wherever possible, the same reference numerals are used in the drawings and the description to refer to the same or like parts. The present invention provides a system and a method for management of building information and automatic payment system, depending on the progress of a building construction. The system for managing information related to an under-construction building structure, monitors one or more construction operations related to the construction of the building structure and include one or more data capturing devices for monitoring the one or more construction operations. Examples of the one or more construction operations include but not limited to construction, designing, developing, maintaining electrical operations and other required operations for maintaining a building, and the like.

In a preferred embodiment, the one or more data capturing devices include cameras, and the cameras capture images or videos, individually or in combination, to monitor the one or more construction operations and analyzing the progress of the building construction through the captured images or videos. The cameras can be wireless or wired, individually or in combination, and may be mounted on poles around the site of the under-construction building structure enveloping the building from all the sides. Further, the cameras are preferably installed at any location on the site, in or around the under-construction building structure. For example, the cameras are preferably installed outside as well as inside the under-construction building structure.

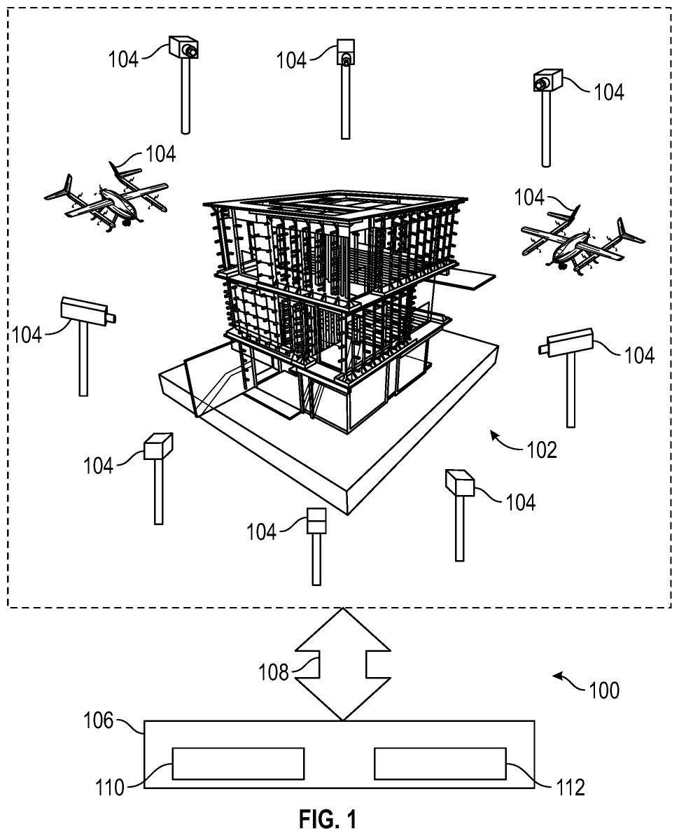

Referring to FIGS. 1-4, the system 100 monitors an under-construction building structure 102 surrounded from the outside by one or more data capturing devices 104. As mentioned above, the data capturing device 104 is preferably a wireless pole mounted camera. The data capturing devices 104 are the devices or sensors that capture any data information, either in the form of digital or analogous, or in the combination, related to the one or more construction operations of the building.

Examples of the data capturing devices 104 include, but not limited to cameras, CCD imagers, CMOS imagers, depth sensors, GPS sensors, moisture sensors, heat sensors, direction sensors, microphones, and the like. It would be readily apparent to those skilled in the art that various types of the data capturing devices 104 may be envisioned without deviating from the scope of the present invention.

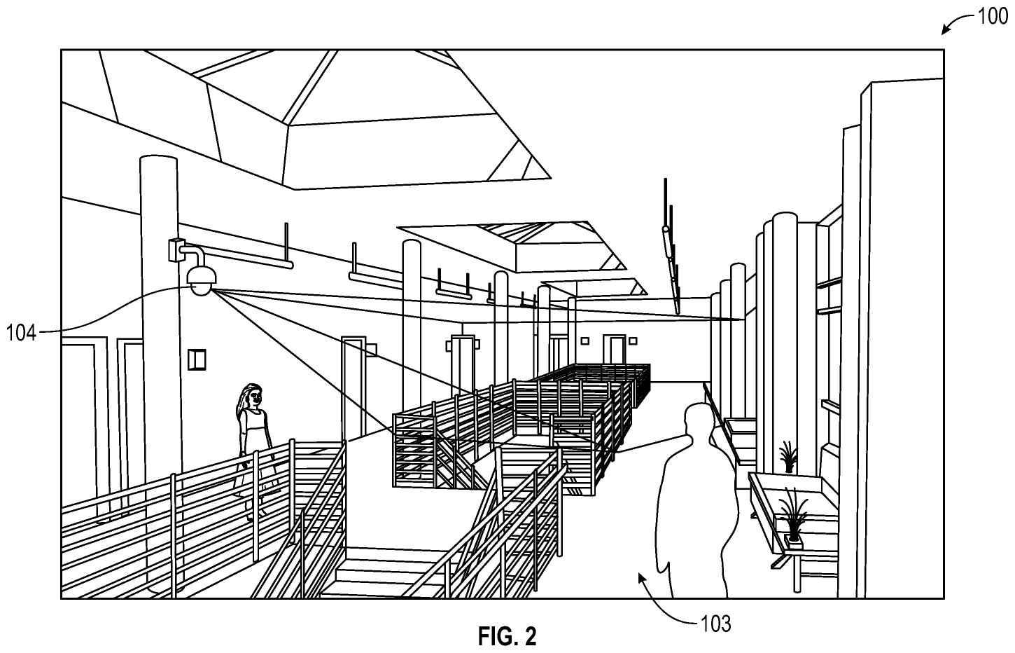

The terms ‘under-construction building structure 102’ and ‘building 102’ are used interchangeably in the present description, without deviating from the scope of the present invention. The data capturing devices 104 are installed outside of the building 102 as shown in FIG. 1, whereas the data capturing devices 102 are also installed inside 103 of the building (102, shown in FIG. 1) as shown in FIG. 2.

Further, the data capturing devices 104 acquire the data information related to the one or more construction operations of the building 102, at a predetermined capture time, and the predetermined capture times are separated by an hourly, daily, weekly or monthly time intervals. It would be readily apparent to those skilled in the art that various forms of pre-determined capture time may be envisioned without deviating from the scope of the present invention.

Hereinafter throughout the description, the data capturing devices 104 has been interchangeably written as wireless cameras 104, pole mounted camera 104 without deviating from the scope of the present invention. For example, each pole mounted camera 104 is programmed to acquire the two-dimensional (2D) images at predetermined capture time, and the predetermined capture times are separated by an hourly, daily, weekly or monthly time intervals.

In another embodiment, the data capturing device 104 is a wireless camera. As mentioned above, the wireless cameras 104 are adapted to be positioned at a plurality of respective locations around the building 102. The wireless camera 104 captures images, videos, individually or in combination, of the under-construction building structure 102 from the plurality of locations around the site of the building 102.

Preferably, the wireless cameras 104 also capture two-dimensional (2D) images, videos, individually or in combination, of the building 102. In another embodiment, the images are two-dimensional (2D) images, and are converted or reconstructed into three-dimensional (3D) images later on. It would be readily apparent to those skilled in the art that the data capture from the data capturing devices 104 may be envisioned in any multi-dimension form without deviating from the scope of the present invention.

Further, the system 100 also includes a computing device 106 that is in communication with the plurality of data capturing devices 104 via a communication network 108 to receive captured data related to the construction operations of the under-construction building structure 102. The computing device 106 and the plurality of data capturing devices 104 communicates via a wired communication network or a wireless communication network, or a combination of both.

The communication network 108 herein after in the description is written interchangeably as network 108, wireless communication network 108 and wired communication network 108, without deviating from the scope of the present invention. Examples of the wired communication network 108 include but not limited to Ethernet, optical communication, cable networks, LAN, serial cables, and the like. Examples of the wireless communication network 108 include but not limited to a short-range or a long-range wireless network, Bluetooth, IrDa, ZigBee, IEEE802.11a/b/g/n/f/ac/ax, WLAN, WAN, and the like.

Preferably, the computing device 106 and the data capturing devices 104 communicates directly with each other over the network 108 or communicates over the Internet via the network 108. Also, the computing device 106 is any computing device that is able to process and store data information and communicate with other devices, including but not limited to laptops, desktops, PCs, smart phones, tablets, server devices, and the likes, having a memory storage device and a processor such as a microcontroller, a controller etc.

It would be readily apparent to those skilled in the art that various types of wired communication network, wireless communication network and the computing device 106 may be envisioned without deviating from the scope of the present invention.

In a preferred embodiment, the data capturing devices 104 sends captured data to the computing device 106 via the network 108. For example, the wireless camera 104 sends captured images and videos, e.g., captured 2D images, to the computing device 106 via the wireless network 108. As mentioned, the computing device 106 includes a memory storage device 110 to store data. The memory storage device 110 stores a plurality of building construction drawings for the construction of the under-construction building structure 102 and the site related to the under-construction building structure 102. The building construction drawings are the final intended plan drawings of the under-construction building structure 102.

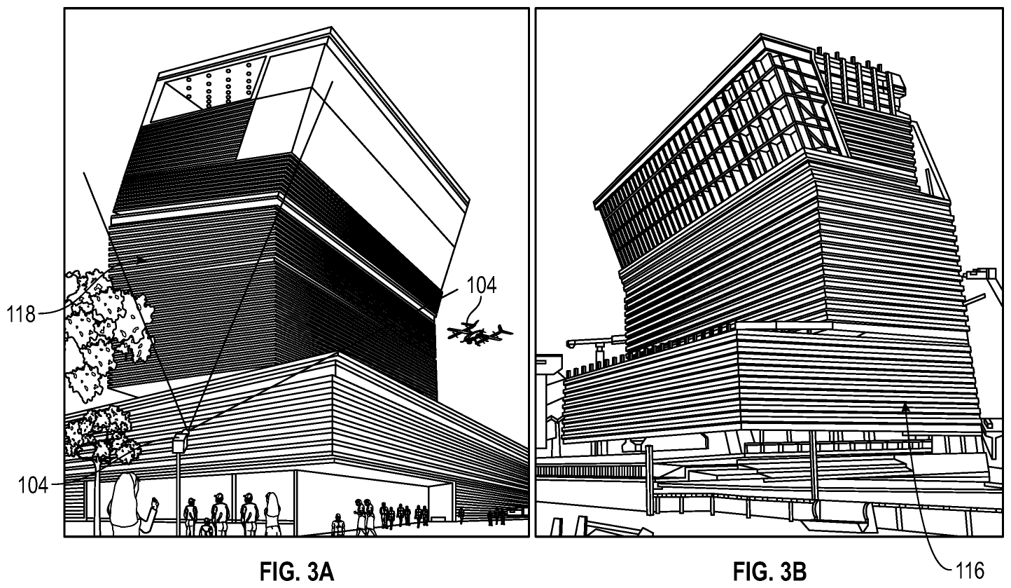

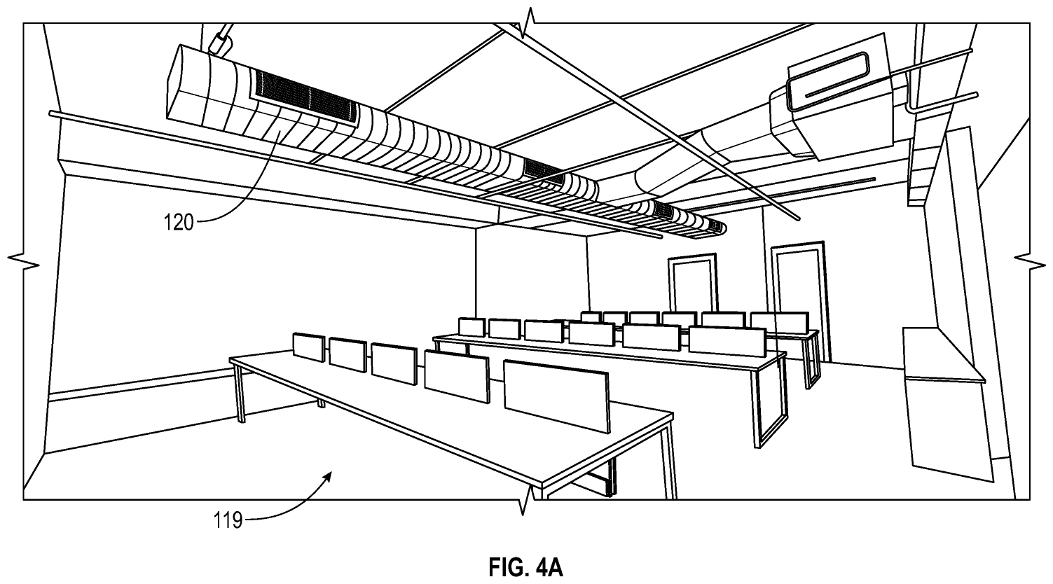

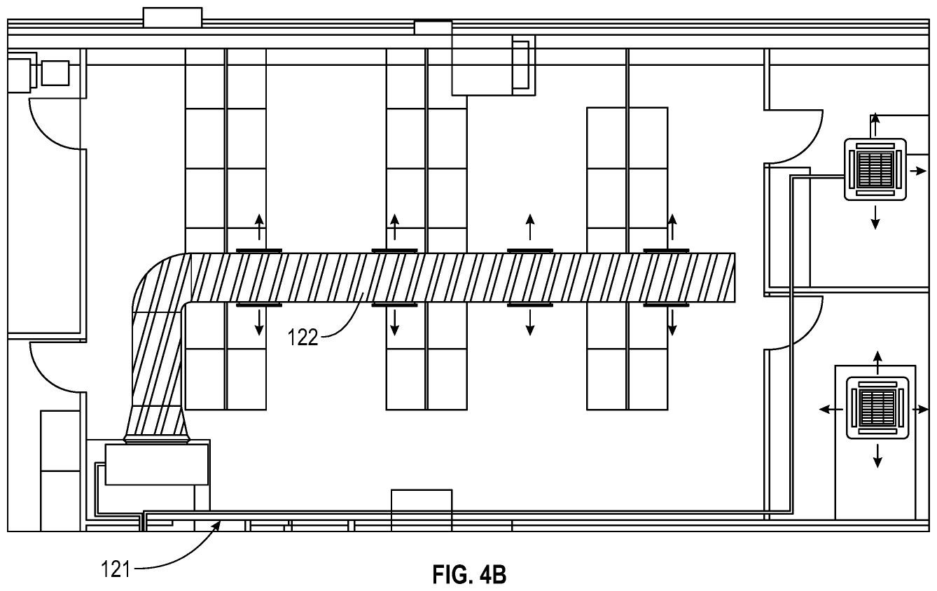

Referring to FIGS. 3 and 4, the building construction drawings 116 and 119 are the intended plan drawings of the outside and inside of the final constructed building, respectively. The final intended plan drawing include designs and drawings for all final intended plan operations for the under-construction building 102, for example related to electrical connections/fixtures of the building, room/hall/office space construction, or the like. Thus, the computing device 106 receives all the captured data information from the data capturing devices 104, wherein, the captured data information is one of any information related to the construction operations of the under-construction building 102.

After receiving the captured data information, the computing device's 106, processor 112, performs operation mapping on the final intended plan drawings of the final building site with the captured data information related to the building 102, wherein the processor 112 can be internally or externally attached with the computing device 106. The operation mapping yields progress information about the progress of the construction of the building 102 by mapping and comparing the actual intended plan drawings (e.g., 116 and 121) with the captured data information (e.g. 118 and 119), respectively.

The operation mapping yields information about the progress information of the constructions of the building 102. The progress information includes information related to the progress of the ongoing construction, any errors or defects detected in the construction, and the future requirement in the construction, depending on the current progress of the construction, and any other direct or indirect related information.

In an example, referring to FIGS. 3A and 3B, the computing device 106 compares the building construction drawings 116 and 121, that are the intended plan drawings of the outside and inside of the final building, respectively, with the captured images and of the outside 118 and the inside 119 of the under-construction building 102, respectively, to yield the progress information of the construction of the building 102.

Similarly, for exemplary purposes as shown in FIGS. 4A and 4B, the computing device 106 compares the intended plan drawings 121 of the inside of the building showcasing a duct 122 with the actual image 119 of the inside of the building. The computing device 106 compares parameter like position of duct 122 in intended plan drawings 121 with the position of duct 120 from the actual photographs captured by the data capturing devices 104 positioned at the under construction building 102.

The computing device 106 receives all the captured data information from the data capturing devices 104 in real time or near real time, and processes the information to perform operation mapping in real time or near real time. Further, the computing device 106 provides the progress information about the construction of the building 102 to local and remote officials, over a wireless or wired network, or a combination of both. Additionally, the progress information about the construction of the building 102 is also stored in a cloud-based server for any required and authorized personnel to fetch that information anytime, anywhere.

The computing device 106 further includes a shared database configured to store a blockchain on the memory storage device 110. In another embodiment, the shared database is accessible via the Internet. In another embodiment, the computing device 106 also include input devices configured to allow the officials involved in the construction of the building 102, for example, the contractors, lenders, vendors and inspectors, to record aspects of the building 102 in the blockchain.

Furthermore, the plurality of building construction drawings includes a plurality of sets of building construction drawings, where each set of the building construction drawings shows information about a portion of the whole final intended plan drawings. One set of building construction drawings may be referred to as a “predetermined milestone”. For example, intended plan drawings for constructing till first floor of a building may include one set of building construction drawings and may be referred to as a “predetermined milestone”.

The memory storage device 110 also includes predetermined payment schedule, that is a scheduled payment to operators and officials related and involved in the construction of the building 102. The officials include contractors, engineers, architects, electricians and the like. The predetermined payment schedule is an automatic payment schedule for paying remunerations to the officials involved in the construction of the building 102 as and when a predetermined milestone is achieved.

Hence, whenever a predetermined milestone is achieved, all the officials involved in the achievement of this predetermined milestone, are automatically paid using the system 100, which is described as below. The achievement of the predetermined milestone is regularly monitored by the data capturing devices 104 and processed and analyzed by the computing system 106 by performing operation mapping to understand about the progress of the predetermined milestone.

Each predetermined milestone that includes a respective set of building construction drawings, is associated with a respective payment amount defined by the predetermined payment schedule. In another embodiment, the computing device 106 performs the operation mapping, that includes a viewpoint determination of milestone matches between the captured two-dimensional (2D) images and the respective sets of building construction drawings associated with each predetermined milestone. After performing the viewpoint determination of milestone matches, the computing device 106 generates feedback or notification in the form of an electronic communication related to the payment of an official involved in the construction of the predetermined milestone.

The examples of an electronic communication message or a notification includes but not limited to an SMS, an email, instant message, voice message, haptic feedback and the like. It would be readily apparent to those skilled in the art that various forms of electronic communication may be envisioned without deviating from the scope of the present invention.

The computing system 106 sends the electronic communication to a financial institution/system that is authorized to release to an official/engineer a predetermined payment amount, associated with the milestone match in accordance with the predetermined payment schedule. The computing system 106 sends the electronic communication to a financial institution/system upon determination of a match in the viewpoint determination of milestone matches.

The present invention offers various advantages such as the financial institution/system releases the associated payment as it is intimated to do so through the electronic communication. In another embodiment, the financial institution/system is a bank account. Examples of the financial institutions/systems include, but not limited to an accounting department, or any finance person or any authorized financial official. In another embodiment, the financial institution/system has an escrow account adapted to release the payment amount to the account associated with the official/engineer involved in the construction of the building 102 according to the predetermined payment schedule associated with the milestone match. In another embodiment, the payment is released via an electronic funds transfer.

The computing device 106 preferably records in the blockchain a smart contract for the predetermined payment schedule for a construction project at the building construction site 102. The smart contract is a product database which defines a plurality of construction materials for the building construction drawings. Additionally, the smart contract comprises at least one term of a building construction transaction, where the term of a building construction transaction includes building construction transaction comprising a retainage, or a penalty.

The system 100 also allows to store the building construction drawings within the blockchain on the memory 110 as a Non-Fungible Token (NFT), adapted to tokenize an ownership of the building construction drawings for the building construction site 102. Further, the building construction drawings may be encrypted to maintain security of the information.

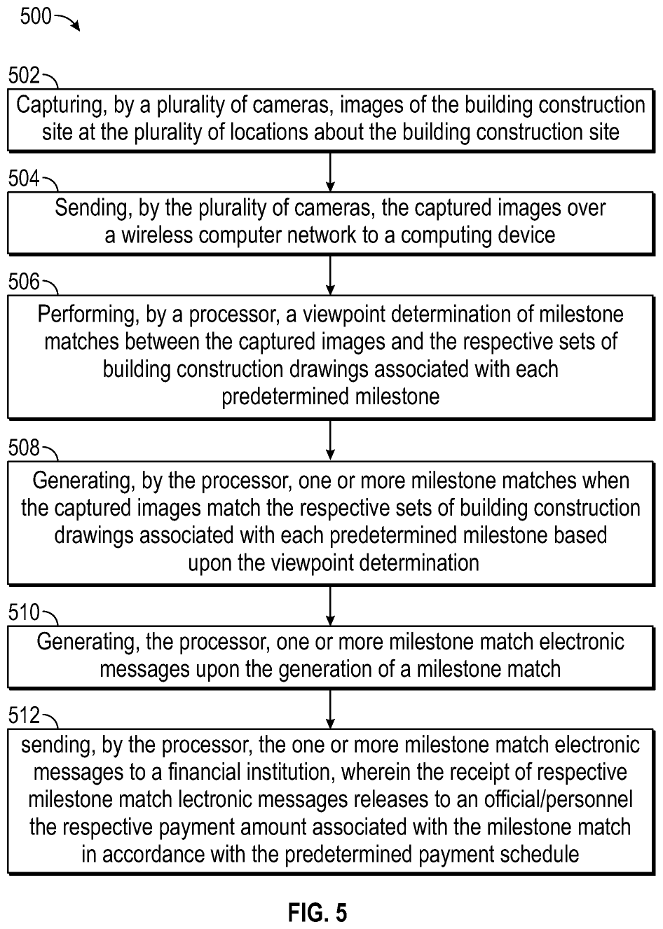

Referring to FIG. 5 that illustrates a flowchart showing a method 500 for managing building information and payment transfers. The method 500 of the present invention is explained in detail in conjunction with the FIGS. 1-4. The method 500 includes a step 502 of capturing, by the data capturing devices 104, data information, either in the form of digital or analogous, or in combination, related to the one or more construction operations of the building construction site 102.

The step 502 is followed by a step 504, of sending, by the plurality of data capturing devices 104, the captured images or videos or both, over the wired or wireless computer network 108 to the computing device 106. After receiving the captured data information at the step 504, the computing device 106, using the processor 112, performs operation mapping, at a step 506, to determine a viewpoint determination of milestone matches between the captured images and the respective sets of building construction drawings associated with each pre-determined milestone.

While performing the operation mapping, that includes a viewpoint determination of milestone matches, the computing device 106 detects and generates, by the processor 112, one or more milestone matches, when the captured data information matches with the respective sets of building construction drawings associated with each predetermined milestone based upon the viewpoint determination included in the operation mapping, at a step 508. After performing the viewpoint determination of milestone matches at step 506 and generating the milestone matches at the step 508, the computing device 106 generates an electronic communication upon the generation of a milestone match, at a step 510.

At a step 512, the computing system 106 sends the electronic communication to a financial institution/system that is authorized to release to an official/engineer a payment amount, associated with the milestone match in accordance with the predetermined payment schedule. The computing system 106 sends the electronic communication to a financial institution upon determination of a match in the viewpoint determination of milestone matches. In another embodiment, the computing device 106 sends electronic messages related to one or more milestone matches to a financial institution/system, where the receipt of respective milestone match electronic messages, releases to an official/personnel, a respective predetermined payment amount associated with the milestone match in accordance with the predetermined payment schedule.

In another embodiment though not shown in Figures, the method 500 includes a step of receiving first input from a first user identifying a term of a building construction transaction between the first user and a second user; and a step of deploying a smart contract that corresponds to the term of the building construction transaction, where the smart contract comprises a program that guides the performance of the one term of the building construction transaction.

The method 500 also preferably stores the building construction drawings within the blockchain on the memory 110 as a Non-Fungible Token (NFT) adapted to tokenize an ownership of the building construction drawings for the building construction site 102. In another embodiment, the method 500 includes, storing a shared database on a blockchain on the memory 110, wherein the shared database is accessible via the Internet. The method 500 also includes storing the predetermined payment schedule in the memory 110 that further includes storing the predetermined payment schedule within a blockchain in the memory 110.

In another embodiment, the method 500 includes storing an International Building Code database on the memory 110, and where the viewpoint determination of code compliance can be performed by matching the captured data information, e.g., the 2D images, with the respective International Building Code database associated with each predetermined milestone, and the milestone matches are generated when the captured data information, e.g., the 2D-images, matches the respective International Building Code database associated with each predetermined milestone based upon the viewpoint determination of code compliance matches.

The present system and method for managing the building construction information and automatic payment mode offers various advantages such as providing real or near real time information on the progress of the building construction operations, and about defects or errors occurring in the building construction operations so that they are corrected within the time.

Further, the present system and method allows timely payments to the people involved and related to the building construction operations, for example, builders, contractors, operators, maintenance officials, engineers, architect and the like, based on the progress of the building construction operations. Further, remote and local personnel can easily and in real time be informed about the progress of the construction, anytime anywhere using the present system. Further, the present system saves money, skill, labour and time incurred in the building management.

Internet connectivity and a dynamic customer database provide product promotion capabilities and consumer access. Product information and promotional information is preferably applied to the outer layer of the building construction information and automatic payment system, as tailored to the user's desired marketing strategies. For instance, advertising is preferably displayed on the front surface of the top surface of the building construction information and automatic payment system. Advertising with the building construction information and automatic payment system provides mechanisms to promote specific marketing initiatives, such as marketing different mixes of brands, as well as additional local and global advertising, such as University-brand specific or geographical-brand specific advertising, through embodiments of the building construction information and automatic payment system. Since the building construction information and automatic payment system, embodiments of the disclosed invention overcome the aesthetic shortcomings of stickers or taping signs, by providing clean, professional looks.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

The drawings and the forgoing description give examples of embodiments. Those skilled in the art will appreciate that one or more of the described elements may be very well combined into a single functional element. Alternatively, certain elements may be split into multiple functional elements. Elements from one embodiment may be added to another embodiment. For example, the orders of the processes described herein may be changed and are not limited to the manner described herein. Moreover, the actions of any flow diagram need not be implemented in the order shown; nor do all of the acts necessarily need to be performed.

Also, those acts that are not dependent on other acts may be performed in parallel with the other acts. The scope of embodiments is by no means limited by these specific examples. The components of the system including the devices and related technologies mentioned above are collectively used to improve performance of the monitoring and managing the progress in the construction of any building structure.

Numerous variations, whether explicitly given in the specification or not, such as differences in structure, dimension, and use of material, are possible. Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

This invention is susceptible to considerable variation within the spirit and scope of the appended claims.

All U.S. patents and publications identified herein are incorporated in their entirety by reference thereto.

The claimed invention is:

1. A camera booth implemented building information management and payment system comprising:
a plurality of wireless pole mounted cameras wirelessly connected to a computing device through a wireless computer network, the plurality of wireless pole mounted cameras adapted to be positioned at a plurality of respective locations about a building construction site, each wireless pole mounted camera programmed to capture two-dimensional (2D) images of the building construction site at the plurality of locations about the building construction site, each wireless pole mounted camera programmed to send the captured two-dimensional (2D) images over the wireless computer network to the computing device;
the wireless computer network connected to the Internet;
the computing device comprising
at least one processor,
a memory storage device coupled to the at least one processor,
wherein a plurality of building construction drawings for a building construction site are stored on said memory storage device, wherein a predetermined payment schedule is stored on said memory storage device,
wherein a plurality of predetermined milestones are stored on said memory storage device, each predetermined milestone comprising a respective set of building construction drawings of the plurality of building construction drawings, each predetermined milestone associated with a respective payment amount defined by the predetermined payment schedule;
wherein the computing device is programmed to perform viewpoint determination of milestone matches between the captured two-dimensional (2D) images and the respective sets of building construction drawings associated with each predetermined milestone;
wherein, said computing device is programmed to send an electronic communication over the Internet adapted for receipt by a financial institution, wherein said financial institution comprises a bank account configured to release to at least one contractor the respective payment amount associated with the milestone match in accordance with the predetermined payment schedule.

2. The camera booth implemented building information management and payment system of claim 1, wherein the wireless computer network comprises a cloud application on a cloud server network device.

3. The camera booth implemented building information management and payment system of claim 1, wherein each pole mounted camera is programmed to acquire the two-dimensional (2D) images at predetermined capture time, wherein the predetermined capture times are separated by an hourly, daily, weekly or monthly time interval.

4. The camera booth implemented building information management and payment system of claim 1, wherein the computing device is programmed to reconstruct a series of three dimensional (3D) modeled scenes of the building construction site from the two-dimensional (2D) images.

5. The camera booth implemented building information management and payment system of claim 1, the computing device further comprising a shared database configured to store a blockchain on said at least one memory storage device, wherein said shared database is accessible via the Internet.

6. The camera booth implemented building information management and payment system of claim 5, further comprising input devices configured to allow contractors, lenders, vendors and inspectors to record aspects of the building construction site in the blockchain.

7. The camera booth implemented building information management and payment system of claim 6, wherein said input devices access the blockchain via the Internet.

8. The camera booth implemented building information management and payment system of claim 5, further configured to record in the blockchain a smart contract for the predetermined payment schedule for a construction project at the building construction site.

9. The camera booth implemented building information management and payment system of claim 8, wherein the building construction drawings are stored within the blockchain on the memory storage device as a Non-Fungible Token (NFT) adapted to tokenize an ownership of the building construction drawings for the building construction site.

10. The camera booth implemented building information management and payment system of claim 9, wherein the building construction drawings are encrypted.

11. The camera booth implemented building information management and payment system of claim 8, wherein the smart contract comprises a product database which defines a plurality of construction materials for the building construction drawings.

12. The camera booth implemented building information management and payment system of claim 8, wherein the smart contract comprises at least one term of a building construction transaction.

13. The camera booth implemented building information management and payment system of claim 8, wherein the at least one term of a building construction transaction comprises a retainage.

14. The camera booth implemented building information management and payment system of claim 8, wherein the at least one term of a building construction transaction comprises a penalty.

15. The camera booth implemented building information management and payment system of claim 1, further comprising an electronic communication sent from the computing device to the financial institution upon determination of a match by the computing device.

16. The camera booth implemented building information management and payment system of claim 1, wherein said released payment is via an electronic funds transfer.

17. The camera booth implemented building information management and payment system of claim 1, further comprising a financial institution having an escrow account adapted to release said payment amount to a contractor according to the predetermined payment schedule.

18. A method for implementing a building information management and payment system comprising steps of:
(a) positioning a plurality of wireless pole mounted cameras at a plurality of respective locations about a building construction site, the plurality of wireless pole mounted cameras programmed to respectively capture two-dimensional (2D) images of the building construction site at the plurality of locations about the building construction site, each wireless pole mounted camera programmed to send the captured two-dimensional (2D) images over the wireless computer network to the computing device;
(b) wirelessly connecting said plurality of wireless pole mounted cameras to a computing device through a wireless computer network, said wireless computer network connected to the Internet, said computing device having at least one processor coupled to at least one memory storage device;
(c) storing a plurality of building construction drawings for a building construction site on said at least one memory storage device;
(d) storing a predetermined payment schedule on said at least one memory storage device;
(e) storing a plurality of predetermined milestones on said at least one memory storage device, each predetermined milestone comprising a respective set of building construction drawings of the plurality of building construction drawings, each predetermined milestone associated with a respective payment amount defined by the predetermined payment schedule;
(f) capturing, by the plurality of wireless pole mounted cameras, two-dimensional (2D) images of the building construction site at the plurality of locations about the building construction site;
(g) sending, by the plurality of wireless pole mounted cameras, the captured two-dimensional (2D) images over the wireless computer network to the computing device;
(h) performing, by the at least one processor, a viewpoint determination of milestone matches between the captured two-dimensional (2D) images and the respective sets of building construction drawings associated with each predetermined milestone;
(i) generating, by the at least one processor, one or more milestone matches when the captured two-dimensional (2D) images match the respective sets of building construction drawings associated with each predetermined milestone based upon the viewpoint determination;
(j) generating, by the at least one processor, one or more milestone match electronic messages upon the generation of a milestone match;
(j) sending, by the at least one processor, the one or more milestone match electronic messages over the Internet to a financial institution comprising a bank account, wherein the receipt of respective milestone match electronic messages releases to at least one contractor the respective payment amount associated with the milestone match in accordance with the predetermined payment schedule.

19. The method for implementing a building information management and payment system of 18, further comprising:
a step of receiving first input from a first user identifying at least one term of a building construction transaction between the first user and a second user; and
a step of deploying a smart contract that corresponds to the at least one term of the building construction transaction, wherein the smart contract comprises a program that guides performance of the at least one term of the building construction transaction.

20. The method for implementing a building information management and payment system of 19, further comprising the step of storing a shared database on a blockchain on said memory storage device, wherein said shared database is accessible via the Internet.

21. The method for implementing a building information management and payment system of 20, herein the step (c) of storing the plurality of building construction drawings for a building construction site on said at least one memory storage device comprises storing the plurality of building construction drawings within the blockchain on the memory storage device as a Non-Fungible Token (NFT) adapted to tokenize an ownership of the building construction drawings for the building construction site.

22. The method for implementing a building information management and payment system of 20, wherein the step (d) of storing the predetermined payment schedule on said at least one memory storage device comprises storing the predetermined payment schedule within a blockchain on the at least one memory storage device.

23. The method for implementing a building information management and payment system of 18, further comprising storing an International Building Code database on the memory storage device.

24. The method for implementing a building information management and payment system of 23, further comprising, prior to the step (i), a step of performing, by the at least one processor, a viewpoint determination of code compliance matches between the captured two-dimensional (2D) images and the respective International Building Code database associated with each predetermined milestone, wherein step (i) further comprises generating, by the at least one processor, one or more milestone matches when the captured two-dimensional (2D) images match the respective International Building Code database associated with each predetermined milestone based upon the viewpoint determination of code compliance matches.

25. The method for implementing a building information management and payment system 18, wherein capturing the two-dimensional (2D) images further comprises capturing the two-dimensional (2D) images once every day.
